(19) United States
(12) Patent Application Publication
(10) Pub. No.: US 2009/0237246 A1
(43) Pub. Date: Sep. 24, 2009

(54) DRIVEWAY ALERT SYSTEM WITH CAR ID

(75) Inventors: Theodore A. White, Norwalk, CT (US); Stanley W. Albrechtsen, Centereach, NY (US); Ashot Akopyan, Brooklyn, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/050,696

(22) Filed: Mar. 18, 2008

(51) Int. Cl. G08B 13/00

(52) U.S. Cl. 340/541; 340/5.2; 340/10.1

(57) ABSTRACT

A security/notification or alert system and method including a specified secure area and an electronic identification device coupled to a trespassing or visiting entity. The electronic identification device transmits a particular identification when the trespassing/visiting entity enters the specified area. A sensor device detects entry of the trespassing/visiting entity into the specified area and transmits an alert signal to a control device when the trespassing/visiting entity is detected. The control device communicates that the trespassing/visiting entity has entered the specified area, and also identifies the entity and communicates the particular identification of the trespassing/visiting entity.

### FIELD OF THE INVENTION

The present invention relates to a security/notification system and method for notifying of a detected trespassing or visiting entity in a specified area, and more specifically, a security/notification system and method for identifying a detected trespassing or visiting entity in a specified area.

### BACKGROUND OF THE INVENTION

Generally, many properties belonging to homes, estates, businesses or college campuses have extensive grounds, lengthy driveways, and/or multiple entrances and exits to the property. For example, a residential home may have a long driveway leading up to the house. Notification or annunciator systems for alerting residents that a vehicle is entering their driveways are known.

One problem with current notification systems is that although the user is alerted to a vehicle entering the driveway, the identity of the vehicle is unknown to the user. For example, the user does not know if the vehicle is someone in the family or a known user, or a stranger. Further the user does not know if the vehicle is entering the driveway or exiting the driveway.

It would therefore be desirable to provide a system which alerts residents or appropriate personnel that a vehicle or other entity is entering their driveway and identifies the vehicle. Additionally, it would be desirable for the system to have the capability to determine and communicate whether the vehicle is either entering or existing the driveway.

### SUMMARY OF THE INVENTION

In an aspect of the invention, an alert system includes at least one sensor device having a detection zone for detecting entry of an entity in the detection zone. An electronic identification device coupled to an entity, and the electronic identification device including a transceiver for transmitting a particular identification signal in response to a request signal. A transceiver in the sensor device being initiated by the sensor device to send the request signal to the entity requesting the particular identification signal. The transceiver determining the entity has an electronic identification device when the transceiver receives the particular identification signal from the electronic identification device. The transceiver sending the particular identification signal identifying the entity or sending an alert signal when no particular identification signal is received by the transceiver. A control device for receiving the particular identification signal identifying the entity or the alert signal from the transceiver in the sensor device. The control device providing a first notification signal using the particular identification of the entity or a second notification signal indicating no particular identification signal for identifying the entity was received. In another embodiment of the invention, the control device categorizes the entity using the particular identification. The categories include known and unknown entities. The first and second notification signals may include a visual display and/or auditory communication to a user. The sensor device may include a PIR (passive infrared device) for detecting entry of the entity into the detection zone. The transceiver of the electronic identification device may be a radio transceiver. The entity may be a vehicle. In another embodiment, the control device determines and communicates the direction of motion of the entity. The system may further include, multiple sensor devices positioned in spaced relation to each other along a route of motion of the entity, and the control device determines the direction of motion of the entity using the particular identification signal or the alert signal, and communicates the direction of the entity. Further, determining the direction of motion of the entity may include analyzing which of two sensor devices detects the entity first. The system may further include a camera for photographing the entity and transmitting the photograph to the control device for display.

In anther aspect of the invention, a method for providing an alert upon entering a detection zone includes: detecting entry of an entity into a detection zone using a sensor device; sending a request signal to the entity using a transceiver in the sensor device; transmitting a particular identification signal from an electronic identification device coupled in the entity in response to the request signal; determining the entity has the electronic identification device when a particular identification signal is received by the transceiver in the sensor device; sending the particular identification signal identifying the entity to a control device; sending an alert signal to the control device when no particular identification signal is received by the transceiver; and receiving the particular identification signal identifying the entity or the alert signal from the transceiver in the sensor device at the control device; notifying a user of the particular identification of the entity using the control device; and notifying the user when no particular identification signal for identifying the entity was received using the control device. The method may further include: determining the direction of motion of the entity; and notifying the user of the direction of the entity using the control device.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram depicting a notification system including a passive infrared (PIR) sensor and a control panel connected to a display and a chime; and

FIG. 2 is a block diagram of house having a driveway and sensor devices for detecting a vehicle.

### DETAILED DESCRIPTION OF THE INVENTION

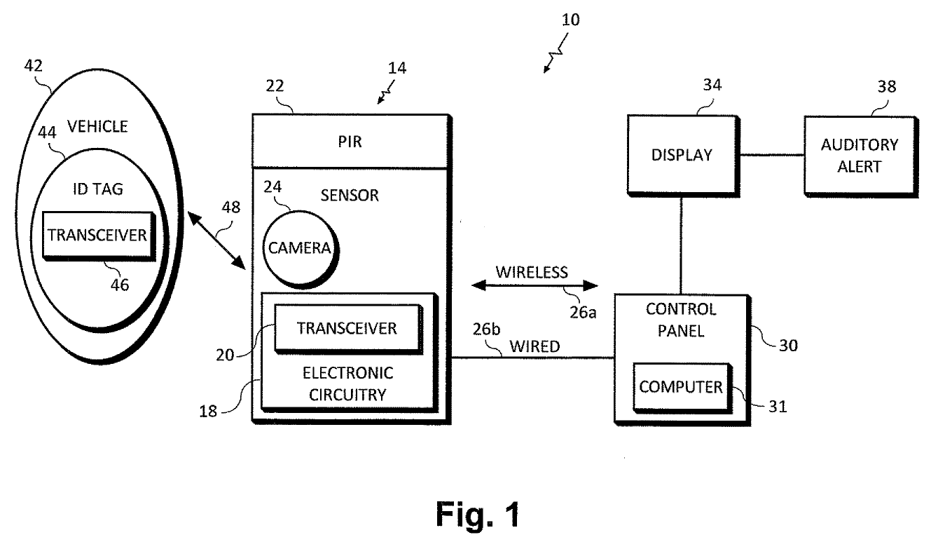

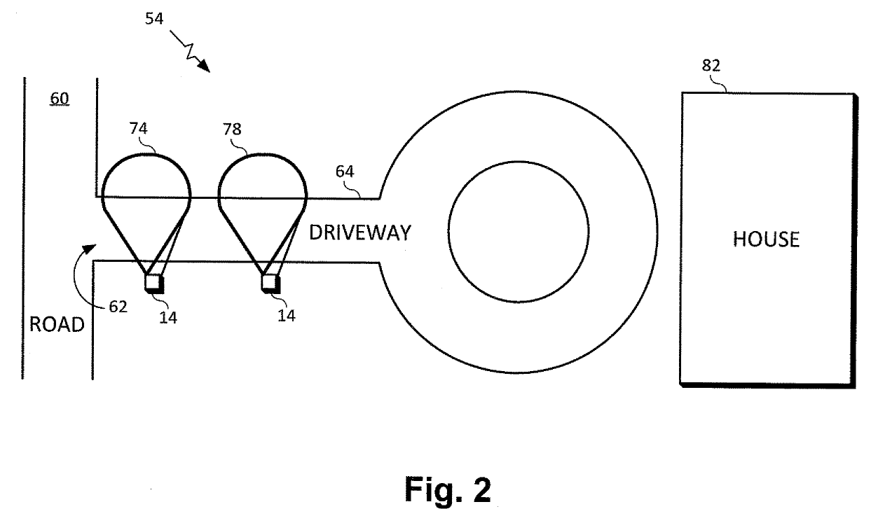

An illustrative embodiment of a security and notification system and method for the same 10, as shown in the FIGS. 1 and 2, includes a sensor device 14. In one embodiment of the invention, the sensor device 14 includes a passive infrared (PIR) sensor 22 connected to electronic circuitry 18 capable of reading and analyzing a signal from the PIR sensor 22 for detection of a heat emitting or radiation emitting entity entering a detection zone 74 (shown in FIG. 2) of the PIR sensor 22. In the present embodiment of the invention, the sensor device 14 is adapted to detect a visiting or trespassing entity embodied as a vehicle 42. The entity may include a bicycle, or various motor scooters or motorcycles, or a boat entering a canal or dock area. The PIR sensor 22 can detect at least three heat sources in a vehicle, the engine, the exhaust, and the occupants of the vehicle, and headlights if they are on. In another example, as is readily apparent, the radiated heat from a person on a bicycle can be detected by the PIR sensor 22.

The sensor device 14 further includes a transceiver 20 connected to the electronic circuitry 18 for providing an alert of a detected entity. The transceiver receives the detection signal from the PIR sensor 22 and transmits an alert signal to a control device embodied as a control panel 30, typically located inside a residence or building. The alert signal includes a notification component and an identification component. The alert signal communicates the entry of any entity into the specified area, whether known or unknown. The alert signal also provides security for the specified area by, for example, communicating to a security system the entrance of a trespasser or an intruder, or communicating the entry of an entity into a secure area.

The sensor device 14 is connected to the control panel 30 using either a wireless connection 26a or a wired connection 26b. The control panel 30 is electrically connected to a display 34, and an auditory alert device such as a chine 38 via a lead 36. The display 34 is for showing a picture or video of the vehicle 42 when entering a specified area which will notify and identify the vehicle to a user who can take appropriate action for securing the area. The specified area is a predefined area of notification and identification which may include a secure area, and in the present embodiment of the invention includes a driveway area 54, shown in FIG. 2. Similar to the display 34, the chime 38 communicates the vehicle 42 has entered the secure area 54. In an alternative embodiment, the display 34 and chime 38 may be integral with the control panel 30. Another alternative includes the control panel 30 connected to other devices for remotely displaying or signaling the detection of the vehicle 42 on, for example, a cellular telephone or wireless device.

In another embodiment, an electronic identification device embodied as a vehicle identification (ID) tag 44 is coupled to the vehicle 42. The vehicle ID tag 44 transmits a signal 48 which contains a particular identification embodied as a vehicle identification (or vehicle ID) to the sensor device 14 using a transceiver 46 in the vehicle ID tag 44 when the vehicle 42 enters the driveway area 54. The vehicle ID tag 44 may be removably attached to the vehicle 42, for example, to the windshield, or to the back of the rear view mirror, or as a clip-on to a visor. In an alternative embodiment, the vehicle ID tag 44 may be part of an existing vehicle security system, for instance, LOJACK®.

More specifically, the vehicle ID tag 44 includes the radio transceiver 46 for receiving a transmitted message from the sensor device 14, and for transmitting a reply to the sensor device 14 including the vehicle ID which identifies the vehicle 42. For example, a three digit code included in the radio frequency (RF) message would allow up to eight family members or friends to be identified.

In one embodiment of the invention, the control panel 30 categorizes the vehicle 42 using the vehicle ID from the vehicle ID tag 44. More particularly, the vehicle ID tag 44 transmits 48 a unique vehicle ID for each vehicle ID tag 44 for reception by the sensor 14 which, in turn, transmits the vehicle ID to the control panel 30. The control panel 30 analyzes any received vehicle ID, and is capable of identifying the vehicle ID using a computer program stored in a computer 31 in the control panel 30. The computer program is programmed to associate the vehicle ID with a particular vehicle 42 and the driver of the vehicle 42, after the vehicle ID and the associated vehicle 42 and driver have been identified and entered into the computer 31. Thus, for example, the control panel 30 can categorize a plurality of vehicles as known or unknown vehicles and the display and chime can indicate to the user whether the vehicle is known or unknown to the system 10.

In one embodiment, referring to FIG. 2, two sensor devices 14, which may be mounted, for example, on posts, are positioned at predetermined locations and in spaced relation to each other along a driveway 64 to a house 82. The first sensor 14 is at the entrance to the driveway 62 and the second sensor 14 is further along the driveway towards the house 82. Each of the sensors 14 include the PIR sensor 22 and the transceiver 20. The driveway 64 is off the main/public road 60, and thus, the secure area or property area 54 starts approximately at the entrance to the driveway 62. The PIR sensor 22 of the sensor device 14 projects a detection zone 74, 78, respectively, from the sensor devices 14. The detection zones 74, 78 traverse the driveway 64 in parallel detections zones. Thus, a vehicle 42 will enter or trespass in one of the detection zones 74, 78 first, depending if the vehicle 42 is entering or exiting the driveway 64, and thus the control panel 30 can determine the direction of the vehicle 42. The control panel 30 can then communicate whether the vehicle 42 is entering or exiting the driveway 64 using the display 34, along with any other information programmed into the computer 31. If the vehicle is not recognized in the system, the control panel 30 can communicate that the vehicle is an unknown vehicle, and if it is entering or exiting the driveway 64.

In the embodiment of the present invention, referring to FIG. 1, a plurality of vehicle ID tags 44 are coupled to a multiplicity of automobiles 42, and each of the plurality of vehicle ID tags 44 includes a different identification, i.e., vehicle ID particular to the vehicle 42, and thereby, identifies the vehicle or typical driver of the vehicle 42. The vehicle ID which is communicated by the PIR sensor 14 to the control panel 30 via wireless or wired connections 26a, 26b, respectively, is analyzed by the computer 31 of the control panel 30. If the vehicle ID is known to the control panel 30, the vehicle 42 can be identified in a variety of ways, such as, a distinct chime 38 or displaying the driver's name or respective name of the vehicle 42, and/or displaying the vehicle 42 itself, or displaying the group the vehicle ID belongs to, such as “Family”. If the vehicle ID is unknown, the vehicle 42 can be identified as a unknown vehicle in a variety of ways, such as, a distinct chime for unknown vehicles, or a text display of stating “unknown vehicle” or the like, and/or displaying the unknown vehicle 42 itself. Displaying the vehicle 42 is achieved in the present embodiment of the invention using a camera 24 in the PIR sensor 14 for transmitting a video or picture of the vehicle 42 to the control panel for displaying on the display 34.

Thus, in the embodiment of the present invention, a homeowner of a large home or estate having a long driveway to the home can be alerted or notified that someone is entering or exiting their driveway. Therefore, the system 10 is a desirable addition to a home security system.

In one embodiment using the security system and method 10 of the present invention, the system 10 is programmed via a control panel keypad by a homeowner to indicate a vehicle 42 enters the driveway with a vehicle ID tag 44 having a unique vehicle ID. The panel or keypad in the house chimes a first tone indicating a known vehicle ID and displays “Family Member” and/or the name of the family member, e.g., Mom, Dad, Jane, etc., which could also be programmed into the computer 31 and displayed. When a vehicle enters the driveway without a vehicle ID, the panel or keypad chimes a second tone indicating an unknown vehicle and display “Unknown vehicle”. The system 10 uses the two staggered sensor device 14 (FIG. 2) with sensor devices 14 to detect whether the vehicle 42 is entering or exiting the driveway. The system could be programmed to only indicate vehicles entering the driveway, exiting, entering and exiting, or both. In another embodiment, the control panel can be programmed to not chime at vehicles having a vehicle ID, but to only chime at unknown vehicles, i.e., vehicles not having a vehicle ID and thus lacking a vehicle ID tag 44. The system can also keep a record of activity similar to a telephone log of all detected vehicle activity. This would indicate to the homeowner if a vehicle entered their property while they were absent from the premises or otherwise preoccupied. Also, the system can be used such that a guardian or responsible party can access the recorded time a charge arrived home. A bypass mode for the security system 10, selected at the control panel, would allow temporary shut off of the security system 10 in the event, for example, many guests are arriving for a party and chiming or the like indicating vehicle arrival is undesirable.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. An alert system, comprising:
at least one sensor device having a detection zone for detecting entry of an entity in the detection zone;
an electronic identification device coupled to an entity, and the electronic identification device including a transceiver for transmitting a particular identification signal in response to a request signal;
a transceiver in the sensor device being initiated by the sensor device to send the request signal to the entity requesting the particular identification signal, the transceiver determining the entity has an electronic identification device when the transceiver receives the particular identification signal from the electronic identification device, and the transceiver sending the particular identification signal identifying the entity or sending an alert signal when no particular identification signal is received by the transceiver; and
a control device for receiving the particular identification signal identifying the entity or the alert signal from the transceiver in the sensor device, and the control device providing a first notification signal using the particular identification of the entity or a second notification signal indicating no particular identification signal for identifying the entity was received.

2. The system of claim 1, wherein the control device categorizes the entity using the particular identification.

3. The system of claim 2, wherein the categories include known and unknown entities.

4. The system of claim 1, wherein the first and second notification signals include a visual display and/or auditory communication to a user.

5. The system of claim 1, wherein the sensor device includes a PIR (passive infrared device) for detecting entry of the entity into the detection zone.

6. The system of claim 1, wherein the transceiver of the electronic identification device is a radio transceiver.

7. The system of claim 1, wherein the entity is a vehicle.

8. The system of claim 1, wherein the control device determines and communicates the direction of motion of the entity.

9. The system of claim 1, further including multiple sensor devices positioned in spaced relation to each other along a route of motion of the entity, and the control device determining the direction of motion of the entity using the particular identification signal or the alert signal, and the control device communicating the direction of the entity.

10. The system of claim 9, wherein determining the direction of motion of the entity includes analyzing which of two sensor devices detects the entity first.

11. The system of claim 1, wherein the sensor device further includes a camera for photographing the entity and transmits the photograph to the control device for display.

12. A method for providing an alert upon entering a detection zone, comprising:
detecting entry of an entity into a detection zone using a sensor device;
sending a request signal to the entity using a transceiver in the sensor device;
transmitting a particular identification signal from an electronic identification device coupled in the entity in response to the request signal;
determining the entity has the electronic identification device when a particular identification signal is received by the transceiver in the sensor device;
sending the particular identification signal identifying the entity to a control device;
sending an alert signal to the control device when no particular identification signal is received by the transceiver; and
receiving the particular identification signal identifying the entity or the alert signal from the transceiver in the sensor device at the control device;
notifying a user of the particular identification of the entity using the control device; and
notifying the user when no particular identification signal for identifying the entity was received using the control device.

13. The method of claim 12, further including:
determining the direction of motion of the entity; and
notifying the user of the direction of the entity using the control device.
